(19) United States
(12) Patent Application Publication
(10) Pub. No.: US 2019/0033555 A1
(43) Pub. Date: Jan. 31, 2019

(54) PHASE DETECTION AUTOFOCUS WITH DIAGONAL LINE DETECTION

(71) Applicant: QUALCOMM Incorporated, San Diego, CA (US)

(72) Inventor: Jisoo Lee, San Diego, CA (US)

(21) Appl. No.: 15/662,767

(22) Filed: Jul. 28, 2017

(51) Int. Cl. G02B 7/28; G02B 7/34; G02B 7/36; G03B 13/36; H04N 5/232; H04N 5/369; H04N 5/378; H04N 9/04

(52) U.S. Cl. CPC G02B 7/285; G02B 7/34; G02B 7/365; H04N 9/045; H04N 5/23212; H04N 5/3696; H04N 5/378; G03B 13/36

(57) ABSTRACT

An autofocus control system for an image capture device comprises one or more processors configured to receive a set of image data, determine whether the set of image data has at least one diagonal edge, and output a first signal in response to detecting at least one diagonal edge in the image data. The one or more processors are configured for analyzing a plurality of phase detection (PD) data from a plurality of PD pixels and outputting a phase difference value and a confidence level, including setting the confidence level to a predetermined value in response to the first signal. A PD autofocus controller is responsive to at least one of the phase difference value or the confidence level for outputting a lens position control signal.

### CROSS-REFERENCE TO RELATED APPLICATIONS

None

### STATEMENT REGARDING FEDERALLY SPONSORED RESEARCH OR DEVELOPMENT

None

### BACKGROUND

### Field

This disclosure relates to autofocus systems for image capture devices.

### Description of Related Art

Many image capture devices use phase detection autofocus (PDAF) systems. PDAF systems can include sparse patterns of phase detection (PD) pixels distributed among imaging pixels in a color image sensor. The distributed PD pixels are provided in pairs, for example left-right pairs. Within each pair, the PD pixels are configured to capture light at different phase angles from each other. When light from a region of interest (ROI) is focused in the plane of the sensor, the phase difference is zero. When light from the ROI is not focused in the plane of the sensor, the phase difference is proportional to the distance the primary lens should be moved to bring the light from the ROI into focus at the plane of the sensor. PDAF can determine the optimal focus position for the primary lens based on phase difference measurements at a single lens position, making PDAF much faster than contrast autofocus methods.

### SUMMARY

An autofocus control system for an image capture device comprises one or more processors configured to: receive a set of image data; determine whether the set of image data has at least one diagonal edge; output a first signal in response to detecting at least one diagonal edge in the image data; receive a plurality of phase detection (PD) data from a plurality of PD pixels and output a phase difference value and a confidence level, including setting the confidence level to a predetermined value in response to the first signal; and output a lens position control signal in response to at least one of the phase difference value or the confidence level.

An autofocus control system for an image capture device comprises means for receiving a set of image data; means for detecting at least one diagonal edge in a set of image data and for outputting a first signal indicating detection of at least one diagonal edge in the image data. The autofocus control system has a means for receiving a plurality of phase detection (PD) data from a plurality of PD pixels and outputting a phase difference value and a confidence level. The means for receiving the plurality of PD data are configured to set the confidence level to a predetermined value in response to the first signal. The autofocus control system has a means for outputting a lens position control signal in response to at least one of the phase difference value or the confidence level.

A method for autofocus control is disclosed comprising: receiving a set of image data; determining whether the set of image data contains data representing at least one diagonal edge; generating a first signal in response to detection of at least one diagonal edge in the set of image data; determining a phase difference between PD pixel data of a first type and PD pixel data of a second type; determining a confidence level associated with the phase difference, including setting the confidence level to a predetermined value in response to the first signal; and outputting a lens position control signal in response to at least one of the phase difference or the confidence level.

A non-transitory computer-readable storage medium stores computer executable code. The computer executable code comprises: code for receiving a set of image data; code for determining whether the set of image data contains data representing at least one diagonal edge; code for generating a first signal having a value indicating detection of at least one diagonal edge in the set of image data; code for determining a phase difference between PD pixel data of a first type and PD pixel data of a second type; code for determining a confidence level associated with the phase difference, and setting the confidence level to a predetermined value in response to the first signal; and code for outputting a lens position control signal in response to at least one of the phase difference or the confidence level.

### BRIEF DESCRIPTION OF DRAWINGS

FIG. 1 is a block diagram of an exemplary imaging system.

FIG. 2A is a schematic diagram of an imaging sensor for the phase detection autofocus camera of FIG. 1.

FIG. 2B is an exploded cross-sectional view of one of the phase detection pixels in the sensor of FIG. 2A, taken along section line 2B-2B.

FIG. 3A is a diagram showing the path of light rays through a primary lens optimally focusing light on the imaging sensor of FIG. 2A.

FIGS. 3B and 3C are diagrams showing the paths of light rays through a primary lens with the focal plane in front of the imaging sensor of FIG. 2A.

FIG. 4A shows a test pattern used as a target scene for the imaging system of FIG. 1.

FIG. 4B is a diagram showing phase difference and focus values for the target scene of FIG. 4A, plotted against lens position.

FIG. 5A shows a test pattern having diagonal edges, used as a target for the imaging system of FIG. 1.

FIG. 5B is a diagram showing phase difference and focus values for the target image of FIG. 5A, plotted against lens position.

FIG. 5C is a schematic diagram of a sensor having left and right phase detection pixels in different rows from each other, to explain the results in FIG. 5B.

FIG. 6 is a block diagram of the phase detection autofocus (PDAF) system of FIG. 1.

FIG. 7 is a flow chart showing an autofocus method performed by the PDAF system of FIG. 6.

FIG. 8 is a flow chart showing an example of the slanted line detector in FIG. 6.

FIG. 9 is a flow chart of a method of calibrating the slanted line detector of FIG. 8.

### DETAILED DESCRIPTION

This description of the examples should be read in connection with the accompanying drawings, which are part of the entire written description.

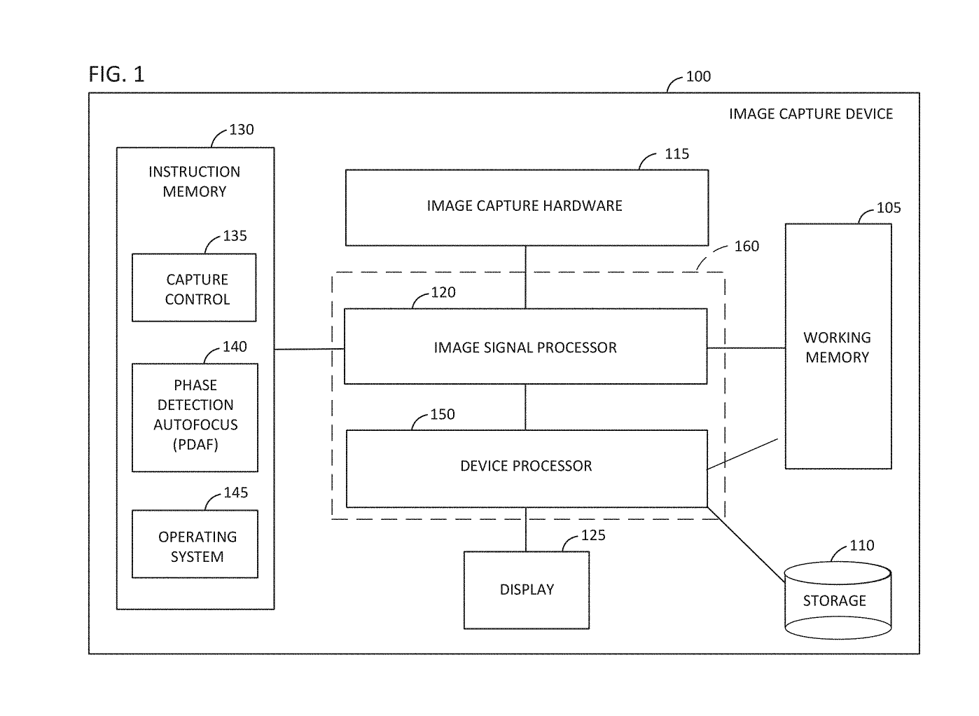

FIG. 1 is a schematic block diagram of an exemplary image capture device 100 including at least one processor 160 linked to image capture hardware 115 for capturing images. The processor 160 is also in communication with a working memory 105, instruction memory 130, storage device 110 and an electronic display 125.

The image capture device 100 and PDAF techniques described herein can provide advantages in many different types of portable and stationary computing devices. The image capture device 100 can also be implemented in a special-purpose camera or a multi-purpose device capable of performing imaging and non-imaging applications. For example, image capture device 100 can be a portable personal computing device such as a mobile phone, digital camera, tablet computer, laptop computer, personal digital assistant, or the like.

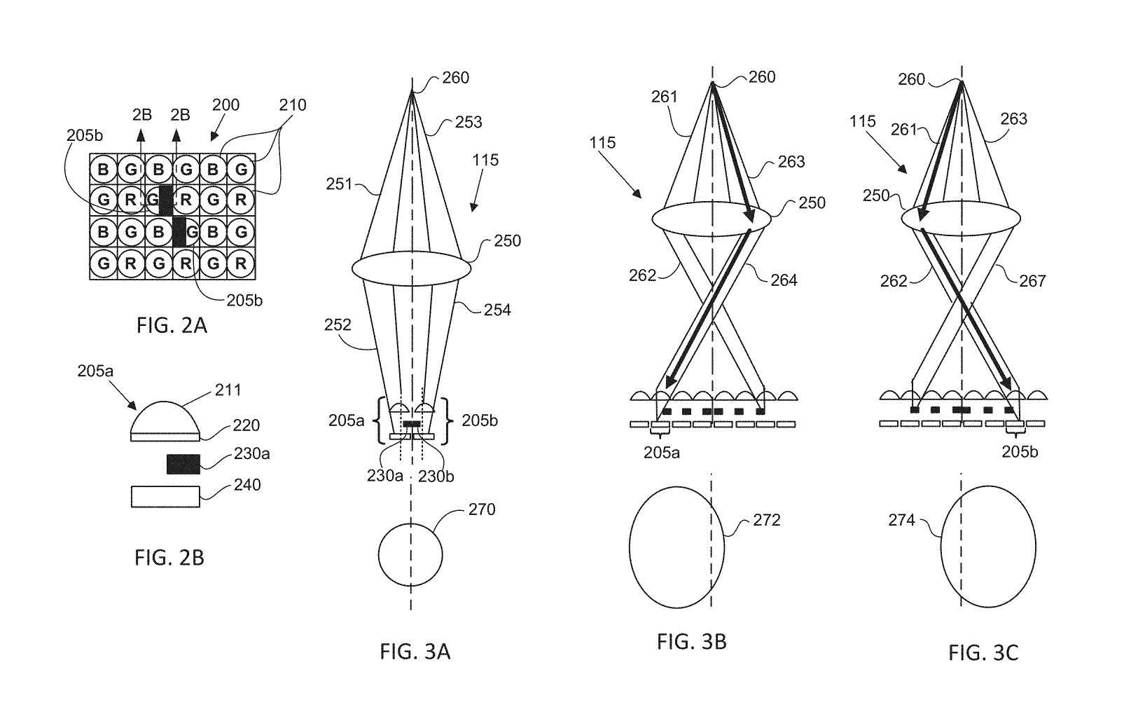

The image capture hardware 115 can include an image sensor 200 having an array of pixels with microlenses 211 and color filters 220, including at least two types of masked phase detection pixels 205a, 205b, discussed below in the description of FIGS. 2A and 2B. The image capture hardware 115 can also have a primary focusing mechanism that is positionable based at least partly on data received from the image signal processor 120 to produce a focused image of a region of interest (ROI) in the target scene.

The at least one processor 160 can include multiple processors, such as an image signal processor 120 and a device processor 150. In other embodiments, the processor 160 has a single central processing unit that performs image signal processing and other operations. Image signal processor 120 can include one or more dedicated image signal processors (ISPs) or a software implementation programmed on a general purpose processor. In some examples, the image signal processor 120 performs phase detection operations. Alternatively, the image sensor 200 can be configured to perform the phase detection operations.

The image signal processor 120 can control image capture parameters such as autofocus and auto-exposure. The image signal processor 120 can also be configured to perform various processing operations on received image data in order to execute PDAF, contrast autofocus, laser autofocus, automatic exposure, automatic white balance, and image processing techniques. Image signal processor 120 can be a general purpose processing unit or a processor specially designed for imaging applications. Image signal processor 120 performs several image processing operations including demosaicing, noise reduction and cross-talk reduction. In some embodiments, the image signal processor 120 also performs post-processing functions, such as cropping, scaling (e.g., to a different resolution), image stitching, image format conversion, color interpolation, color processing, image filtering (e.g., spatial image filtering), lens artifact or defect correction, sharpening, or the like.

As shown in FIG. 1, the image signal processor 120 is connected to an instruction memory 130 for storing instructions and a working memory 105. The instruction memory 130 stores a capture control block 135, a PDAF system 140, and an operating system block 145. The instruction memory 130 can include a variety of additional modules that configure the image signal processor 120 of device processor 150 to perform various image processing and device management tasks. Working memory 105 can be used by image signal processor 120 to store a working set of instructions contained in the modules of memory. Alternatively, working memory 105 can also be used by image signal processor 120 to store dynamic data created during the operation of image capture device 100. For example, in some embodiments, the instruction memory 130 comprises flash memory, and the working memory 105 comprises dynamic random access memory (DRAM). The working memory provides a means for receiving a set of image data from the image capture hardware 115 for processing by ISP 120.

The capture control block 135 can include instructions that configure the image signal processor 120 to adjust the lens position, exposure and white balance of image capture device 100, in response to instructions generated during a PDAF focus operation, for example. Capture control block 135 can further include instructions that control the overall image capture functions of the image capture device 100. For example, capture control block 135 can call the PDAF system 140 to determine lens or sensor movement to achieve a desired autofocus position and output a lens control signal to the lens.

PDAF system 140 stores instructions for executing PDAF, as discussed in the description of FIGS. 2A-3C below. PDAF system 140 can also store instructions for determining center pixel values and virtual phase detection pixel values.

Operating system 145 acts as an intermediary between programs and the processor 160. For example, if the image capture device 100 is a mobile phone or tablet, the operating system can be “APPLE iOS”™, from Apple, Inc., Cupertino, Calif. If the image capture device 100 is a computer, the operating system 145 can be ‘WINDOWS”™ sold by Microsoft Corporation of Redmond, Wash. Operating system 145 can include device drivers to manage hardware resources such as the image capture hardware 115. Instructions contained in the image processing blocks discussed above interact with hardware resources indirectly, through standard subroutines or application program interfaces (APIs) in operating system 145. Instructions within operating system 145 can then interact directly with these hardware components. Operating system 145 can further configure the image signal processor 120 to share information with device processor 150.

Device processor 150 can be configured to control the display 125 to display the captured image or a preview of the captured image to a user. The display 125 can be external to the image capture device 100 or can be part of the image capture device 100. The display 125 can also be configured to provide a view finder displaying a preview image prior to capturing an image. The display 125 can comprise a liquid crystal display (LCD), light emitting diode (LED), or organic light emitting diode (OLED) screen, and can be touch sensitive.

Device processor 150 can write data to storage device 110. The data can include data representing captured images, data generated during phase detection and/or metadata, e.g., exchangeable image file format (EXIF) data. While storage device 110 is represented schematically as a disk device, storage device 110 can be configured as any type of storage media device. For example, the storage device 110 can include a disk drive, such as an optical disk drive or magneto-optical disk drive, or a solid state memory such as a FLASH memory, random access memory (RAM), read-only memory (ROM), and/or electrically-erasable programmable ROM (EEPROM). The storage device 110 can also include multiple memory units.

Although FIG. 1 shows an image capture device 100 having separate components to implement a processor 160 and working memory 105, in other examples these separate components can be combined in a variety of ways. For example, in an alternative example (not shown), the memory components can be combined with processor components in a system on a chip (SOC).

FIGS. 2A and 2B show an example of a sensor 200 suitable for use in the image capture hardware 115 of FIG. 1. The sensor 200 can be a complementary metal oxide semiconductor (CMOS) imaging sensor or a charge-coupled device (CCD) sensor. The sensor 200 has a plurality of imaging pixels 210 and a plurality of phase detection (PD) pixels 205a, 205b. The imaging pixels 210 are arranged in a pattern according to their colors. The imaging pixels 210 can be red, green, and blue (R, G, and B, respectively, in FIG. 2A) type imaging pixels 210 arranged in a Bayer pattern. In other examples, the imaging pixels 210 can be arranged in a cyan, yellow, green, and magenta pattern, a red, green, blue, and emerald pattern, a cyan, magenta yellow, and white pattern, a red, green, blue, and white pattern or other suitable pattern corresponding to a demosaicing algorithm used to interpolate a set of red, green, and blue values for each imaging pixel 210.

FIG. 2A is a schematic view of the sensor 200. Although FIG. 2A shows a sensor with 24 sensing elements for ease of viewing, sensor 200 can have several million sensing elements. FIG. 2B is an exploded view of a phase detection (PD) pixel 205a as viewed along section line 2B-2B of FIG. 2A. The PD pixel 205a has three components in common with the imaging pixels 210, including a microlens 211, a color filter 220, and a photodiode 240. The PD pixels 205a, 205b also include a partial mask 230a, 230b that prevents light passing through part of the microlens 211 from reaching the photodiode 240.

The sensor 200 has two types of PD pixels 205a and 205b corresponding to partial masks 230a and 230b, respectively. The partial masks 230a and 230b are located on opposite sides of the PD pixels 205a and 205b, respectively. In some embodiments of sensor 200 the partial mask 230a or 230b is located on the right side or the left side of each PD pixel 205a and 205b, as shown in FIG. 3A. A PD pixel 205a having a partial mask 230a on the right side is referred to as a “left PD pixel”, because light entering the left portion of the “left PD pixel” 205a (to the left of the partial mask 230a) can reach the left side of the photodiode 240. Similarly, the PD pixel 205b having a partial mask 230b on the left side is referred to as a “right PD pixel” 205b, because light entering the right portion of the “right PD pixel” 205b (to the right of the partial mask 230b) can reach the right side of the photodiode 240. In other embodiments (not shown), a partial mask is provided on the top half of a “bottom PD pixel”, and a partial mask is on the bottom half of a “top PD pixel”.

Many commercially available sensors are equipped with left PD pixels 205a and right PD pixels 205b, but without top PD pixels or bottom PD pixels. Other sensors are equipped with top PD pixels and bottom PD pixels, but without left PD pixels or right PD pixels. The examples described below include a sensor 200 having left PD pixels 205a and right PD pixels 205b. The method can also be applied to other cameras having top PD pixels and bottom PD pixels. Although FIG. 2A shows one left pixel 205a and one right pixel 205b, the sensor can have any desired number of PD pixel pairs.

Although the examples below describe PD pixels 205a and 205b having partial masks, the systems and methods described herein are not limited to PD pixels having partial masks. For example, the system can include PD pixels (not shown) having asymmetric microlenses (not shown). An asymmetric microlens can cause a phase difference between light passing through the left side of the asymmetric microlens and light passing through the left side of the asymmetric microlens. Another type of mask-less PD pixel has two photodiodes per microlens, such that light incident in a first direction is collected in a first diode of the two adjacent diodes and light incident in a second direction is collected in a second diode. The system can perform PDAF control based on the light collected by each of the first and second diodes.

FIG. 3A is a schematic diagram of image capture hardware 115 properly focused on an ROI 260 in the target scene. The primary focusing mechanism can be a movable lens assembly having a primary lens 250 positioned to focus light from a region of interest (ROI) 260 the target scene onto the sensor 200. The lens assembly can include several lenses, but for ease of understanding, the lens assembly is represented by the primary lens 250. In other embodiments (not shown), the primary focusing mechanism can be a mechanism (not shown) for moving the sensor 200 relative to the primary lens 250. Light rays 251 and 253 reflected from the ROI 260 pass through the primary lens 250 and emerge as light rays 211 and 254, respectively. Light rays 211 and 254 pass through the partial masks 230a, 230b of left PD pixels 205a and right PD pixels 205b, respectively. The light rays 252 and 254 emerging from the primary lens 250 are in focus at the imaging plane containing the photodiodes 240 of both left PD pixels 205a and right PD pixels 205b. The light rays 252 and 254 collected by the photodiodes 240 have a phase difference of zero (or approximately zero) between light from the left PD pixels 205a and right PD pixels 205b. The focused spot 270 represents the light from the left PD pixels 205a and right PD pixels 205b mapping to the same locations on the photodetectors 230a, 230b.

FIGS. 3B and 3C are schematic diagrams of image capture hardware 115 in which light from the ROI 260 is focused in front of the imaging plane of the sensor 200 (i.e., the image capture hardware 115 is out of focus). FIGS. 3B and 3C both show the primary lens 250 in the same position, but FIGS. 3B and 3C are annotated differently with arrows to emphasize the different rays of light passing through different portions of primary lens 250 and reaching the photodiodes 240 of the left PD pixels 205a and right PD pixels 205b. In both FIGS. 3B and 3C, light rays 261 and 263 from the ROI 260 in the target scene pass through the primary lens 250 and emerge as light rays 262 and 264, respectively. Light rays 262 and 264 pass adjacent to the partial masks 230a and 230b of left PD pixels 205a and right PD pixels 205b with different phase angles from each other. The different phase angles result in a non-zero phase difference (e.g., less than zero degrees or greater than zero degrees) between light detected by left PD pixels 205a and light detected by right PD pixels 205b.

As shown in FIG. 3B, the light 262 is blocked by the left partial masks 230a, but the light 264 passes around the right partial masks 230b and reaches the photodiodes 240 of the left PD pixels 205a with a first phase angle. The spot 272 represents the light from the left PD pixels 205a mapping to a first set of locations on the photodiodes 240, corresponding to a first phase angle.

As shown in FIG. 3C, the light 264 is blocked by the right partial masks 230a, but the light 262 passes around the left partial masks and reaches the photodiodes 240 of the right PD pixels 205b with a second phase angle. There is a non-zero phase difference between the light 264 detected by the left PD pixels 205a in FIG. 3B and the light 262 detected by the right PD pixels 205b in FIG. 3C. The spot 274 represents the light from the right PD pixels 205b mapping to a second set of locations on the photodiodes 240, corresponding to a second phase angle.

The PDAF system 140 determines the phase difference between the phase angles of the light detected by the left PD pixels 205a and the light collected by the right PD pixels 205b. The distance between the current position of primary lens 250 and the position that brings the ROI 260 into focus can be directly determined from the phase difference. This allows the PDAF system to determine the distance between the current position of primary lens 250 (e.g., as shown in FIGS. 3B and 3C) and the position that brings the ROI 260 into focus (as shown in FIG. 3A). The autofocus controller then generates a lens position command to cause the primary lens 250 to move to the focused position.

In FIGS. 3A-3C, the depiction of the image capture hardware 115 as having only a primary lens 250 is simplified for ease of understanding. The image capture hardware 115 can have a complex optical system (not shown) including many lens elements, using the method of generating a lens position command based on the phase difference.

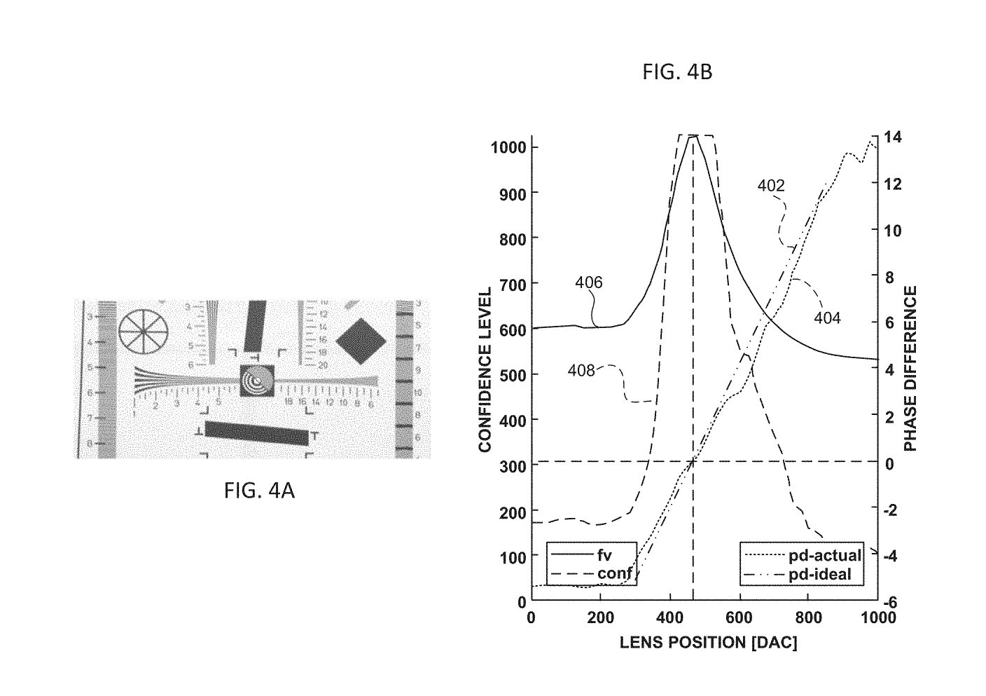

FIG. 4A shows a test image predominantly comprising horizontal patterns and solid patterns. FIG. 4B shows PDAF system data collected using the test image of FIG. 4A. Curve 402 shows an ideal linear model of the phase difference as a function of the lens position for the test image that is in focus when the lens position is 467. For example, the phase difference can be modeled as directly proportional to the distance between the current position of the primary lens 250 and a perfectly focused position of the primary lens 250. Curve 402 has zero phase difference when the lens position is 467. Curve 404 shows the observed phase difference values plotted on the same axis as curve 402. The observed phase difference of curve 404 closely tracks the ideal linear model of curve 402 and has a value of zero when the lens position is 467.

Curve 406 shows a focus value plotted against the lens position for the test image (which is in focus when the lens position is 467). The focus value of curve 406 has a peak of 1000 when the lens position is 467, corresponding to a phase difference of zero. Curve 408 shows the confidence level associated with each lens position. The confidence level can be determined based on a spectral analysis of the image data 170 corresponding to an edge, for example. The confidence level in curve 408 indicates the likelihood that the focus value is correct. The confidence level in curve 408 generally tracks the focus value of curve 406. The confidence level has a peak when the image is in focus, and falls off rapidly as the lens position moves away from the focused position.

In most circumstances, with adequate lighting the confidence level has a peak value when the focus value is accurate. However, in some PDAF systems, target scenes with high frequency patterns may cause the PDAF system to falsely identify a defocus condition while the target scene is actually in focus. For example, with sparsely positioned PD pixels 205a, 205b (for example, a pair of PD pixels 205a and 205b separated by five or more imaging pixels 210 therebetween), high frequency patterns within the ROI 260 can cause an inaccurate phase difference determination. Such inaccurate phase difference measurements may occur when a high frequency signal is sampled at a low frequency. The result of sampling a high frequency signal with a low sampling frequency is referred to as aliasing or aliasing noise.

The PDAF system 140 can analyze values from imaging pixels to provide information about high frequency details within the ROI 260 of the target scene and to identify a sharpest edge in the image data of the ROI 260. Using sharpness metric information about the sharpest edge, the PDAF system can determine a confidence level associated with the phase difference value determined by the PDAF system 140. When the confidence level of a determined phase difference is below a threshold, the PDAF system 140 can initiate an alternative focusing operation (e.g., contrast autofocus or laser autofocus) to ensure a focused image.

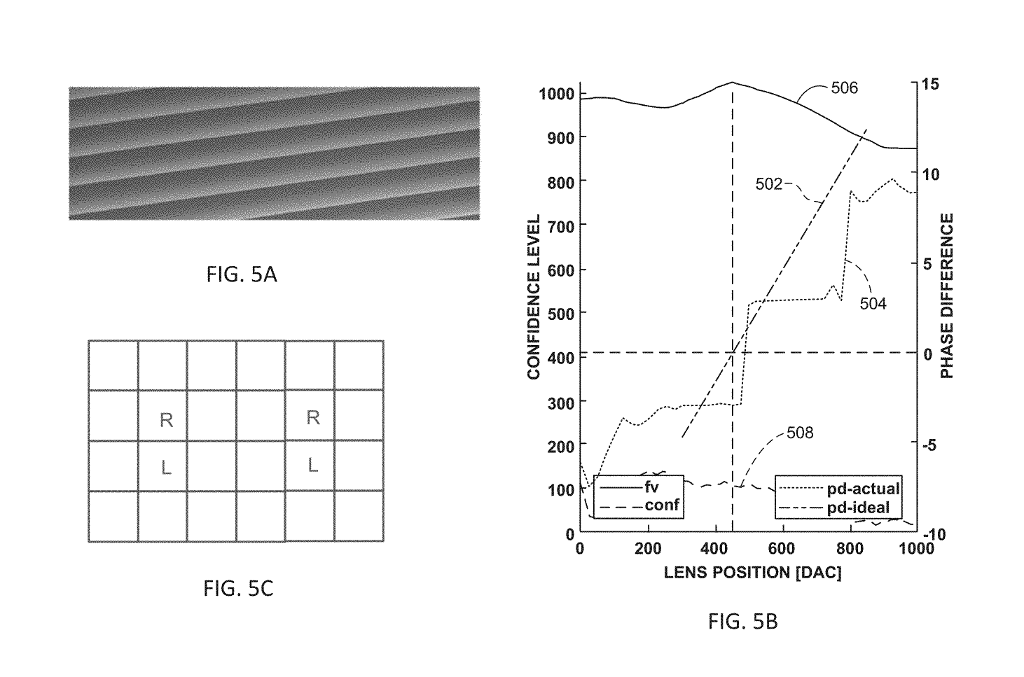

The inventors have observed that the PDAF system 140 provides an inaccurately high confidence level in the case where the ROI 260 of the target scene to be imaged contains one or more diagonal lines or diagonal edges and only small vertical lines or no vertical lines. (An edge can include a line segment or a boundary between two regions having different luminance values from each other. A line includes two edges, and the term “edges” as used below encompasses edges, lines, or any combination of edges and lines.) FIG. 5A shows an image of window blinds viewed from an oblique angle, including a plurality of diagonal edges.

The PDAF system 140 detects vertical edges in the scene. That is, in landscape orientation, vertical edges enable the PDAF system 140 to detect a difference in phase between the light received by the left PD pixel 205a and the right PD pixel 205b with a high confidence level. A horizontal edge in a scene (e.g., a horizon) does not, by itself, enable the PDAF system 140 to determine the phase difference with a high confidence level.

When the scene contains diagonal lines and/or diagonal edges or edges slanted at an angle (within a predetermined range) from the horizontal axis of the sensor 200 in landscape orientation, the PDAF system 140 detects a vertical component in the edge. The predetermined range can be an angle between zero and 45 degrees. In an example, the predetermined range is from about five degrees to about 20 degrees, inclusive. Upon detecting the vertical component, the system determines a phase difference with a high confidence level, even in cases where the lens is not focused.

Similarly, when the scene contains diagonal edges slanted within a predetermined range (e.g., greater than zero and less than 45 degrees) from the vertical axis of the sensor 200 in portrait orientation, the PDAF system 140 detects a horizontal component in the edge. In an example, when the scene contains one or more diagonal edges slanted at an angle from about five degrees to about 20 degrees from the vertical axis of the sensor 200 in portrait orientation, the PDAF system 140 detects a horizontal component in the edge. Upon detecting the horizontal component, the system can determine a phase difference with a high confidence level. Because the confidence level is high, the PDAF system 140 relies on the phase difference to determine the lens position control signal to focus the lens.

FIG. 5B shows the same autofocus parameters shown in FIG. 4B, plotted for the image of blinds in FIG. 5A. Curve 502 shows the ideal linear model of the phase difference as a function of the lens position for a ROI 260 that is in focus when the lens position is 467 (same as the model 402 in FIG. 4A). Ideal curve 502 has zero phase difference when the lens position is about 467.

The observed phase difference 504 deviates from the ideal linear curve 502 over most of the range of lens positions. The observed phase difference 504 is not zero at the focused lens position of 467, but has a large discontinuous jump from about −3 to about +3 when the lens position is about 500.

Curve 506 shows the focus value plotted against the lens position for an ROI 260 in FIG. 5A. Curve 506 indicates that the focus value has a peak of 1000 when the lens position is 467, but never drops below 875 throughout the range of lens positions. Without additional information, curve 506 indicates that the ROI 260 is essentially focused throughout the range of lens positions. However, curve 508 shows that the confidence level associated with the focus values of curve 506 is low throughout the range of lens positions, and does not exceed 150 (out of 1000), even at a lens position of 467, where the ROI 260 is in focus.

Without being limited by any theory, the sensor 200 may have PD pixels arranged in a pattern where right-metal shielded and left-metal shielded pixel pairs occur in different rows, as shown schematically in FIG. 5C. In FIG. 5C, left PD pixels are indicated by “L”, and right PD pixels are indicated by “R”. In a configuration having right and left PD pixels proximal to each other in different rows, the resulting “left” and “right” image may appear as closely overlapping to one another when the primary lens 250 is focused on an ROI. In the case of an ROI having diagonal lines, an arrangement of PD pixels as shown in FIG. 5C can cause the resulting “left” and “right” image to appear as having horizontal shift (i.e. non-zero PD) even in cases where the lens 250 is positioned so the ROI is in focus.

Thus, when the ROI 260 contains one or more diagonal edges, the PDAF system can output a non-zero phase difference with a low confidence level, while the ROI 260 is in focus. Because the confidence level is low, the capture control block 135 initiates an alternative autofocus operation, such as a contrast autofocus operation, so the image capture device 100 can still capture a focused image.

The inventors have also observed cases of images containing diagonal edges, in which the PDAF system outputs a zero or very small phase difference with a high confidence level, while the ROI 260 is out of focus. An incorrect focus value with a high confidence level may mislead the PDAF system 140 into capturing an out-of-focus image.

The inventors have found that a PDAF system having left PD pixels 205a and right PD pixels 205b is likely to generate an inaccurate phase difference value with a high confidence level when the ROI 260 has at least one diagonal edge, oriented from 1 degree to 44 degrees from the horizontal axis of the sensor (assuming the sensor is oriented in landscape imaging orientation). The likelihood of an incorrect focus value and an inaccurate phase difference with a high confidence level is greater in cases where the at least one diagonal edge is oriented in a range from 5 degrees to 20 degrees away from the horizontal axis of the sensor 200.

Similarly, the inventors have found that, in a PDAF system (not shown) having top PD pixels and bottom PD pixels, the PDAF system is likely to generate an inaccurate phase difference value with a high confidence level when the ROI 260 has at least one diagonal edge, oriented from 1 degree to 44 degrees from the vertical axis of the sensor (assuming the sensor is oriented in landscape imaging orientation). The likelihood of sensing an incorrect focus value and an inaccurate phase difference with a high confidence level is greater in cases where the at least one diagonal edge is oriented from 5 degrees to 20 degrees from the vertical axis of the sensor.

In the case where the confidence level is high but the focus value and phase difference are incorrect, relying on the PDAF data can cause the image capture device 100 to collect an out-of-focus image.

The systems and methods described herein detect a condition in which the PDAF system 140 is likely to output an incorrect phase difference with a high confidence level. A PDAF controller is responsive to detection of the condition and outputs a lens position control signal initiating an alternative autofocus operation, such as contrast autofocus or laser autofocus.

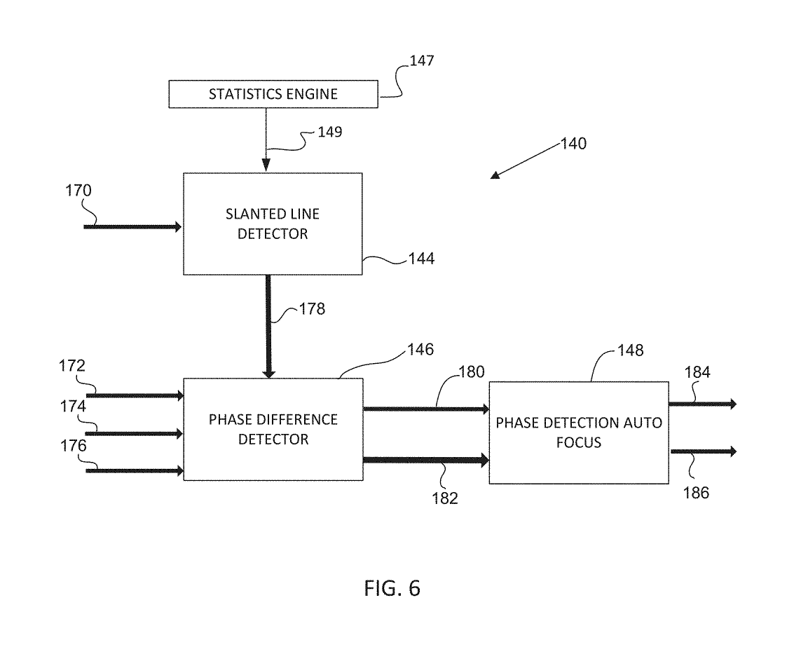

FIG. 6 shows an example of the autofocus control system 140, configured to detect the presence of one or more diagonal edges in the ROI 260, and to automatically initiate a contrast autofocus operation or laser autofocus operation upon detecting the presence of a diagonal edge.

The image data 170 input to the PDAF system 140 have been adjusted to compensate for luminance values 172 received from PD pixels 205a and 205b, before the image data 170 are provided to a slanted line detector 144. For example, if the sensor 200 includes PD pixels 205a and 205b with partial masks 230a and 230b, the luminance values 172 reported by the PD pixels 205a and 205b are substantially less than the luminance values of neighboring imaging pixels 210 without partial-masks 230a. The adjustments to the luminance values 172 from the PD pixels 205a and 205b within the image data 170 avoid artifacts in the image at the locations of the PD pixels 205a and 205b. For example, the adjustments can include applying different weights to the luminance values 172 of the PD pixels 205a, 205b or replacing the luminance values 172 of the PD pixels 205a, 205b with interpolated luminance values based on the luminance values of surrounding imaging pixels 210).

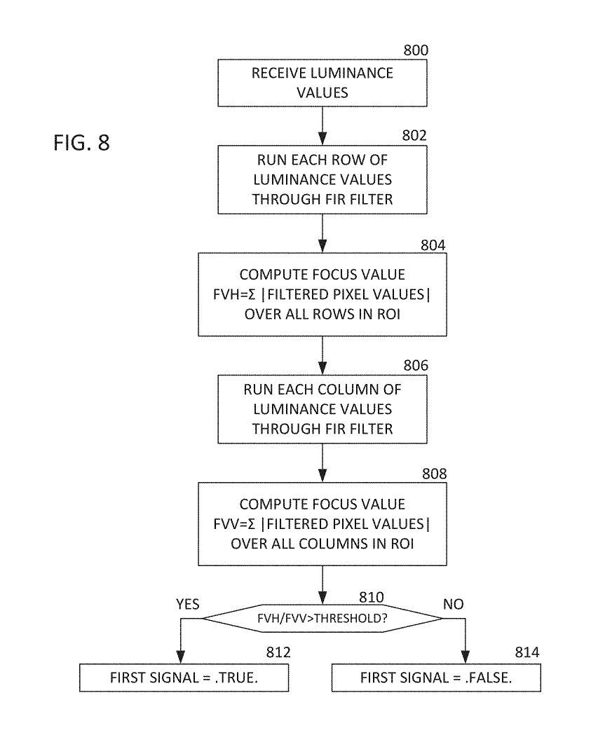

The PDAF system 140 has a means for detecting at least one diagonal edge in a set of image data 170 and for outputting a first signal 178 having a value indicating the image data contain at least one diagonal edge. For example, the means for detecting can be a slanted line detector 144. An example of a slanted line detector 144 is described below within the discussion of FIG. 8. The exemplary slanted line detector 144 is capable of analyzing a set of image data 170 for at least one ROI 260 of the target scene captured by imaging pixels 210. The slanted line detector 144 is configured for outputting a first signal 178 indicating whether the slanted line detector 144 has detected at least one diagonal edge in the image data for a given ROI 260. The diagonal edge can be a line segment (containing two edges) or a boundary between two regions having respectively different luminance values. In an example, the slanted line 144 detector is configured to output the first signal 178 having a value indicating whether the at least one diagonal edge is oriented at an angle having an absolute value greater than zero degrees and less than 45 degrees from a predetermined axis of a pixel array containing the plurality of PD pixels.

For example, the predetermined axis can be parallel to the longer sides of the sensor 200 (i.e., the horizontal axis when the sensor 200 is oriented in landscape mode, or the vertical axis when the sensor 200 is oriented in portrait mode). In another example, the slanted line 144 detector is configured to output the first signal 178 with a value indicating the at least one diagonal edge is oriented at an angle having an absolute value in a range from five degrees to 20 degrees (inclusive) away from the longer side of the pixel array in the sensor 200. Alternatively, the slanted line detector 144 can be configured to output the first signal 178 with a value indicating the slanted line detector 144 determines that a probability of the image data 170 including at least one diagonal edge is at least a threshold value.

The PDAF system 140 includes a means for analyzing a plurality of phase detection (PD) data 172 from a plurality of PD pixels and outputting a phase difference value and a confidence level in response to the first signal 178. The means for analyzing can be a phase difference detector 146. The phase difference detector 146 is configured for analyzing the plurality of phase detection (PD) data 172 from one or more left PD pixels 205a and one or more right PD pixels 205b. The phase difference detector 146 receives phase information 172 from a plurality of left PD pixels 205a and a plurality of right PD pixels 205b. The phase difference detector 146 receives the image capture conditions 174, which include an auto-exposure setting and an indication of the focal length (or lens position). The image capture conditions 174 also include PDAF calibration information 176, which defines the relationship between the phase difference value and the lens position adjustment that will bring the ROI 260 into focus at the plane of the sensor 200. The phase difference detector 146 determines and outputs a phase difference value 180 and a confidence level 182 associated with the phase difference value 180, in response to the value of the first signal 178.

The phase difference detector 146 can determine the confidence level 182 for the phase difference value 180 based on analysis of the frequency components of a sharpest edge in the ROI 260, and/or other factors such as the detected light level and the magnitude of the phase difference. For example, the confidence level 182 may be low for very large phase differences, corresponding to an unfocused primary lens 250. As another example, the phase difference detector 146 may determine a high confidence level 182 for a determined phase difference 180 in the case of photographing a bright scene with a sharp vertical edge.

The exemplary phase difference detector 146 is configured to set the confidence level 182 to a predetermined value (e.g., zero or approximately zero) in response to the value of the first signal 178 from the slanted line detector 144, indicating detection of a diagonal line or diagonal edge. For example, a confidence level of 0.01 may be considered approximately zero, in a case where the PDAF system 140 treats a confidence level of 0.01 as unreliable, and triggers a contrast autofocus operation. The phase difference detector 146 can output the confidence level 182 of zero or approximately zero in response to the value of the first signal 178 indicating detection of at least one diagonal edge in the ROI 260.

The PDAF system 140 includes a means for outputting a lens position control signal in response to the phase difference value 180 and the confidence level 182. For example, the means for outputting a lens position control signal can be a PDAF controller 148. The PDAF controller 148 is responsive to the phase difference value 180 and the confidence level 182 for outputting a lens position control signal 184 and a focus status 186. The lens position control signal 184 is provided to the lens assembly (represented by the primary lens 250) to move the primary lens 250 to a position for bringing the ROI 260 into focus (i.e., the light from the ROI 260 is focused in the plane of the sensor 200. The PDAF controller 148 is configured to activate a contrast autofocus operation or a laser autofocus operation in response to the confidence level 182 being lower than a threshold value. The PDAF controller 148 is also configured to activate the contrast autofocus operation or the laser autofocus operation in response to the confidence level 182 being set at the predetermined value.

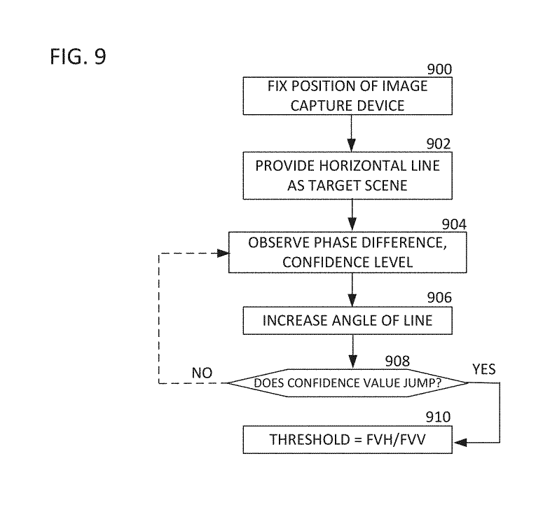

PDAF system 140 can have a statistics engine 147 that performs computations related to the image data, including autofocus, automatic white balance and automatic exposure determination. The statistics engine 147 can also provide the results 149 to the slanted line detector 144, as discussed below in the description of FIG. 9.

Although FIG. 6 shows the slanted line detector 144, phase difference detector 146, phase detection autofocus controller 148, and statistics engine 147 as separate blocks, the slanted line detector 144, phase difference detector 146, phase detection autofocus controller 148, and statistics engine 147 can be implemented as modules executed by one or more processors.

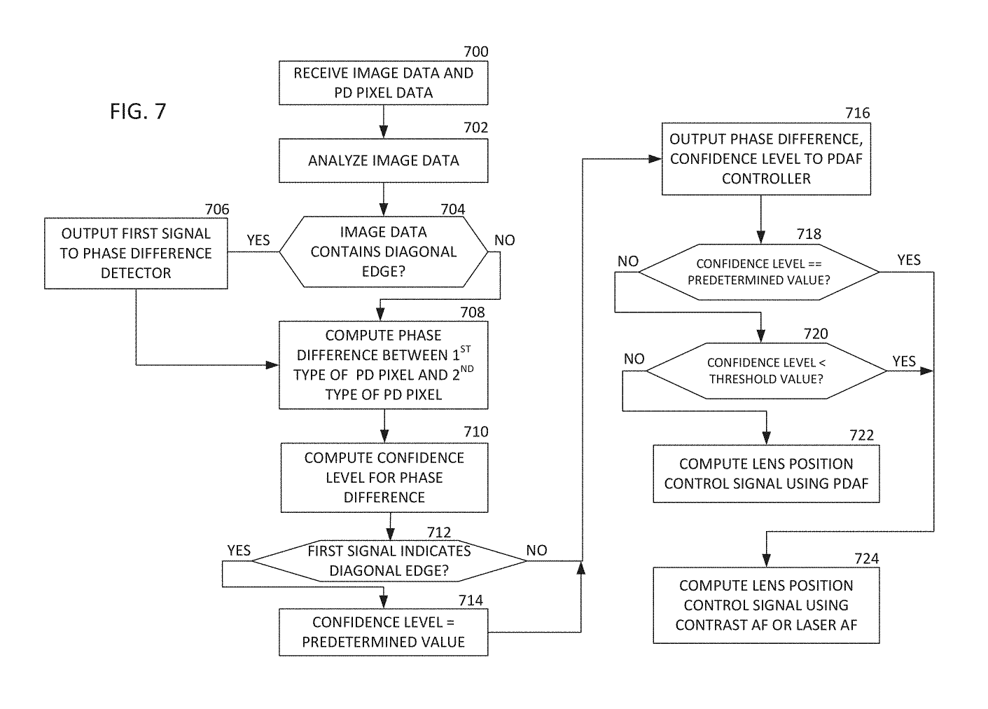

FIG. 7 is a flow chart of a method for autofocus control.

In block 700, the PDAF system 140 receives image data from the imaging pixels 210 and PD data from the left PD pixels 205a and the right PD pixels 205b. The user of the image capture device 100 can activate the autofocus operation by tapping an ROI 260 on the display 125 of the image capture device 100, if the image capture device 100 is a mobile phone, tablet or other computing device with a touch-sensitive display. The user can partially depress a shutter button (not shown) if the image capture device 100 is a dedicated camera. In some devices, such as mobile phones, the autofocus operation is initiated automatically when the camera application is launched.

In block 702, the image signal processor 120 analyzes the set of image data 170.

In block 704, the slanted line detector 144 determines whether the set of image data 170 contains data representing at least one diagonal edge within the ROI. In some embodiments of the PDAF system 140, the slanted line detector 144 determines whether there is a diagonal edge in a predetermined range of angles with respect to the horizontal or vertical axis of the sensor 200. In other embodiments of the PDAF system 140, the predetermined range includes angles from −45 degrees to −1 degree and from +1 degree to +45 degrees. In other embodiments of the PDAF system 140, the predetermined range includes angles from −20 degrees to −5 degree and from +5 degree to +20 degrees. In response to detection of at least one diagonal edge, control passes to block 706. If there is no diagonal edge, control passes to block 708.

In block 706, the slanted line detector 144 generates and outputs a first signal 178 having a value indicating detection of at least one diagonal edge in the set of image data 170. The first signal 178 can be a binary signal having a value of zero, if no diagonal edge is found or a value of one if at least one diagonal edge is detected. Alternatively, the first signal 178 can be a binary signal having a value of .FALSE. if no diagonal edge is found or a value of .TRUE. if at least one diagonal edge is detected. In PDAF systems 140 implemented in hardware or firmware, the first signal 178 can have a high voltage or a low voltage, where one of the voltage values indicates detection of at least one diagonal edge. Alternatively, the first signal can have a fractional value between zero and one indicating the probability that the ROI contains at least one diagonal edge. The slanted line detector 144 provides the first signal 178 to the phase difference detector 146.

In block 708, the phase difference detector 146 determines a phase difference between the PD pixel data of a first type (e.g. from left PD pixel 205a) and PD pixel data of a second type (e.g. from right PD pixel 205b).

In block 710, the phase difference detector 146 determines an initial confidence level. The initial confidence level determination can be based on the light level and/or contrast in the image data 170, for example.

In block 712, the phase difference detector 146 determines whether the first signal 178 received from the slanted line detector 144 has a value indicating detection of at least one diagonal edge. If the value of the first signal indicates a diagonal line has been detected, control passes to block 714. If the value of the first signal 178 indicates no diagonal edge is detected in the ROI 260, control passes to block 716.

In block 714, the phase difference detector 146 sets the confidence level 182 to a predetermined value (e.g., zero or near zero) in the case where the first signal 178 indicates the ROI 260 contains data representing at least one diagonal edge. Then control passes to block 716.

In block 716, the phase difference detector 146 provides the phase difference 180 and the confidence level 182 to the PDAF controller 148.

In block 718, the PDAF controller 148 determines whether the confidence level 182 equals the predetermined value indicating the ROI 260 has at least one diagonal edge. In response to a determination that the confidence level 182 equals the predetermined value indicating the ROI 260 has at least one diagonal edge, the PDAF controller 148 passes control to block 724. If the confidence level 182 is not equal to the predetermined value indicating the ROI 260 has at least one diagonal edge, the PDAF controller 148 passes control to block 720.

In block 720, the PDAF controller 148 determines whether the confidence level 182 is less than a threshold value. (A description of a method for calibrating the PDAF system 140 to select the threshold value is described below in the discussion of FIG. 9.) In response to a determination that the confidence level 182 is less than the threshold value, the PDAF controller 148 passes control to block 724. If the confidence level 182 is greater than or equal to the threshold value, the PDAF controller 148 passes control to block 722.

In block 722, the PDAF controller 148 uses PDAF to determine and output a lens position control signal 184 at least partially in response to the phase difference 180 and the confidence level 182. The lens position control signal controls the primary lens 250 to move to the optimal position for focusing on the ROI.

In block 724, the PDAF controller 148 initiates an alternative focusing operation, such as a contrast autofocus operation or a laser autofocus operation in the case where the confidence level 182 is set at the predetermined value.

FIG. 8 is a flow chart of an exemplary method for detecting a diagonal edge. The slanted line detector 144 can be configured to perform the method of FIG. 8.

In block 800, the slanted line detector 144 receives image data 170 corresponding to at least one ROI 260. The slanted line detector 144 analyzes the luminance component of the image data 170.

In block 802, the slanted line detector 144 passes the image data 170 for the ROI through a filter, such as a finite impulse response (FIR) filter. For example, the slanted line detector 144 can run a 1×3 FIR filter along each individual row of the luminance values of the image data 170. The FIR filter outputs a respective filtered pixel value for each row of the ROI 260. The FIR filter highlights edges with strong vertical components.

In block 804, the slanted line detector 144 determines a first focus score FVH of the image data in a first direction by summing the absolute values of the respective filtered pixel value for each row of the ROI determined in block 802. The PDAF system 140 can have a statistics engine 147 (FIG. 6) that determines FVH and provide provides FVH to the slanted line detector 144.

Blocks 806 and 808 perform operations analogous to blocks 802 and 804, but using filtered pixel values for each column of image data in the ROI. In block 806, the slanted line detector 144 passes the image data 170 for the ROI through a filter, such as an FIR filter. For example, the slanted line detector 144 can run a 3×1 FIR filter along each individual column of the luminance values of the image data 170. The FIR filter outputs a respective filtered pixel value for each column of the ROI 260. The FIR filter highlights edges with strong horizontal components.

In block 808, the slanted line detector 144 determines a second focus score FVV of the image data in a second direction, by summing the absolute values of the respective filtered pixel value for each column of the ROI determined in block 802. The second direction is orthogonal to the first direction. The PDAF system 140 can have a statistics engine 147 (FIG. 6) that determines FVV and provide provides FVV to the slanted line detector 144.

In block 810, the slanted line detector 144 determines a ratio of the first focus score FVH of the image data in the first direction to the second focus score FVV of the image data in the second direction orthogonal to the first direction. If the ratio of FVH/FVV is greater than a threshold value, control passes to block 812. If the ratio of FVH/FVV is not greater than the threshold value, control passes to block 814.

In block 812, the value of the first signal is set to the value indicating the ROI has at least one diagonal edge. For example, the value can be set to “.TRUE.” if the first signal is a logic value, “1” if the first signal has an integer value, or “low” if the slanted line detector is implemented in logic hardware.

In block 814, the value of the first signal is set to the value indicating the ROI has no diagonal edge. For example, the value can be set to “.FALSE.” if the first signal is a logic value, “0” if the first signal has an integer value, or “high” if the slanted line detector is implemented in logic hardware.

In another example, the first signal has a fractional value—based on the ratio FVH/FVV—representing the probability of the image data including at least one diagonal edge. The fractional value can be used to compare two or more regions of interest to determine which ROI has the smallest probability of containing diagonal edges. Then the PDAF controller 148 can select the phase difference corresponding to the ROI with the smallest probability of containing a diagonal edge for a PDAF operation.

Although the exemplary slanted line detector 144 includes FIR filters, the slanted line detector 144 can include other types of filters, such as infinite response filters.

Although an exemplary slanted line detector 144 is described above, the PDAF system 140 can use different techniques for detecting diagonal edges. For example, the slanted line detector 144 can include a deep-learning artificial neural network (ANN) (not shown). The ANN acts as a scene classifier. The ANN can detect target ROIs in which the dominant edge is a diagonal edge.

FIG. 9 is a flow chart of a method for calibrating the slanted line detector 144.

In block 900, the image capture device 100 is fixed at one orientation for the duration of the calibration.

In block 902, a target having a strong horizontal line or edge is used as the target scene. For example, the target can be a white page with a black horizontal line.

In block 904, the phase difference and the confidence value for the phase difference are observed for the horizontal line. In a PDAF system with left PD pixels 205a and right PD pixels 205b, a target scene having only horizontal edges and no vertical edges results in a low confidence level.

In block 906, the target is rotated to increase the angle between the line and the horizontal axis.

In block 908, the slanted line detector compares the confidence level to the most recent previous confidence value. If the confidence level is unchanged or has shown a gradual change, control returns to block 904. The confidence level is expected to be low, so the low confidence value can be trusted.

If the confidence level jumps to a high value, but the lens moves to another unfocused position, control passes to block 910. The high confidence value while the lens remains unfocused indicates that the diagonal edge is causing the PDAF system to output an incorrect confidence level. The jump in the confidence value may be accompanied by a jump in the phase difference.

In block 910, at the angle where the confidence level has a discontinuous jump to a high level, but the lens remains unfocused, the value of FVH/FW is determined, and can be used as the predetermined threshold value for the PDAF system 140. The threshold value can vary from system to system. For example, in one system FVH/FW may reach the threshold value when the line is 5 degrees from horizontal. In another system FVH/FW may reach the threshold value when the line is 15-20 degrees from horizontal.

In some cases, the determined phase difference has a discontinuous jump (e.g., between a first value less than zero and a second value greater than zero) without a corresponding peak in the determined confidence level, as shown in FIG. 5B. The predetermined threshold value can be selected as the value of the ratio FVH/FW at which the determined phase difference has a discontinuous jump between a first (negative) value less than zero and a second (positive) value greater than zero without a corresponding peak in the determined confidence level. Because a phase difference of zero corresponds to an optimum focus position, and a peak in the confidence level is expected at the optimum focus position.

In the examples described above, the PD pixel data includes data from left PD pixel 205a having a right mask and a right PD pixel 205b having a left mask, without data from a PD pixel having a top mask or a bottom mask. The method can also be used where the PDAF system receives data from a PD pixel having a top mask and a PD pixel having a bottom mask, without data from a PD pixel having a left mask or a right mask. To calibrate the threshold of an image capture device having top and bottom PD pixels, instead of beginning with a horizontal line, the calibration begins with a vertical line in the target, and the target is rotated so the line moves away from the vertical axis.

Although the example of FIG. 9 uses a fixed image capture device and a rotating target, the calibration can also be performed by fixing the target with the line in a horizontal position and rotating the image capture device relative to the line.

The methods and system described herein can be at least partially embodied in the form of computer-implemented processes and apparatus for practicing those processes. The disclosed methods can also be at least partially embodied in the form of tangible, non-transitory machine readable storage media encoded with computer program code. The media can include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods can also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods can alternatively be at least partially embodied in application specific integrated circuits for performing the methods.

Although the subject matter has been described in terms of exemplary examples, it is not limited thereto. Rather, the appended claims should be construed broadly, to include other variants and examples, which can be made by those skilled in the art.

What is claimed is:

1. An autofocus control system for an image capture device comprising one or more processors configured to:
receive a set of image data;
determine whether the set of image data has at least one diagonal edge;
output a first signal in response to detecting at least one diagonal edge in the image data;
receive a plurality of phase detection (PD) data from a plurality of PD pixels and output a phase difference value and a confidence level, including setting the confidence level to a predetermined value in response to the first signal; and
output a lens position control signal in response to at least one of the phase difference value or the confidence level.

2. The autofocus control system of claim 1, wherein the one or more processors are configured to activate a contrast autofocus operation or a laser autofocus operation in the case where the confidence level is set to the predetermined value.

3. The autofocus control system of claim 1, wherein the predetermined value is zero or approximately zero.

4. The autofocus control system of claim 1, wherein the one or more processors are configured to determine that the image data has a diagonal edge in in the case where a ratio of a first focus score of the image data in a first direction to a second focus score of the image data in a second direction orthogonal to the first direction is at least a predetermined threshold value.

5. The autofocus control system of claim 4, wherein the plurality of PD pixels include a left PD pixel and a right PD pixel, the first direction is horizontal, and the second direction is vertical.

6. The autofocus control system of claim 4, wherein the one or more processors include a slanted line detector configured to perform the determining.

7. The autofocus control system of claim 1, wherein the one or more processors are configured to output the first signal in the case where the at least one diagonal edge is oriented at an angle having an absolute value greater than zero degrees and less than 45 degrees from a predetermined axis of a pixel array containing the plurality of PD pixels.

8. The autofocus control system of claim 1, wherein the one or more processors are configured to output the first signal in the case where the at least one diagonal edge is oriented at an angle having an absolute value in a range from about five degrees to about 20 degrees from a predetermined axis of a pixel array containing the plurality of PD pixels.

9. The autofocus control system of claim 1, wherein the one or more processors are configured to output the first signal in the case where a slanted line detector of the autofocus control system determines that a probability of the image data including at least one diagonal edge is at least a threshold value.

10. The autofocus control system of claim 9, wherein the first signal includes a value representing the probability of the image data including at least one diagonal edge.

11. An autofocus control system for an image capture device, comprising:
means for receiving a set of image data;
means for detecting at least one diagonal edge in the set of image data and for outputting a first signal indicating detection of at least one diagonal edge in the image data;
means for receiving a plurality of phase detection (PD) data from a plurality of PD pixels and outputting a phase difference value and a confidence level, the means for receiving the plurality of PD data configured to set the confidence level to a predetermined value in response to the first signal; and
means for outputting a lens position control signal in response to at least one of the phase difference value or the confidence level.

12. The autofocus control system of claim 11, wherein the means for detecting is configured to output the first signal in the case where a ratio of a first focus score of the image data in a first direction to a second focus score of the image data in a second direction orthogonal to the first direction is at least a predetermined threshold value.

13. The autofocus control system of claim 11, wherein the means for detecting is configured to output the first signal in the case where the at least one diagonal edge is oriented at an angle having an absolute value in a range from about five degrees to about 20 degrees from a predetermined axis of a pixel array containing the plurality of PD pixels.

14. The autofocus control system of claim 11, wherein the means for detecting is configured to output the first signal in the case when the at least one diagonal edge is oriented at an angle of about five degrees to about 20 degrees from a predetermined axis of a pixel array containing the PD pixels.

15. A method for autofocus control comprising:
receiving a set of image data;
determining whether the set of image data contains data representing at least one diagonal edge;
generating a first signal in response to determining the set of image data has at least one diagonal edge;
determining a phase difference between phase detection (PD) pixel data of a first type and PD pixel data of a second type;
determining a confidence level associated with the phase difference, including setting the confidence level to a predetermined value in response to the first signal; and
outputting a lens position control signal in response to at least one of the phase difference or the confidence level.

16. The method for autofocus control according to claim 15, wherein the lens position control signal initiates a contrast autofocus operation or a laser autofocus operation in the case where the confidence level is set to the predetermined value.

17. The method for autofocus control according to claim 15, wherein determining whether the set of image data contains data representing at least one diagonal edge includes:
determining a ratio of a first focus score of the image data in a first direction to a second focus score of the image data in a second direction orthogonal to the first direction; and
determining whether the ratio is greater than a predetermined threshold value.

18. The method for autofocus control according to claim 17, wherein the predetermined threshold value is a value of the ratio at which the determined phase difference has a discontinuous jump between a first value less than zero and a second value greater than zero without a corresponding peak in the determined confidence level.

19. The method for autofocus control according to claim 17, wherein the predetermined threshold value is a value of the ratio at which the determined confidence level has a peak value or a discontinuous increase, but the determined phase difference does not change between a positive value and a negative value.

20. The method for autofocus control according to claim 15, wherein the PD pixel data includes either:
data from a PD pixel having a left mask and a PD pixel having a right mask, without data from a PD pixel having a top mask or a bottom mask; or
data from a PD pixel having a top mask and a PD pixel having a bottom mask, without data from a PD pixel having a left mask or a right mask.

21. A non-transitory computer-readable storage medium storing computer executable code, comprising:
code for receiving a set of image data;
code for determining whether the set of image data contains data representing at least one diagonal edge;
code for generating a first signal having a value indicating detection of at least one diagonal edge in the set of image data;
code for determining a phase difference between phase detection (PD) pixel data of a first type and PD pixel data of a second type;
code for determining a confidence level associated with the phase difference, and setting the confidence level to a predetermined value in response to the first signal; and
code for outputting a lens position control signal in response to at least one of the phase difference or the confidence level.

22. The non-transitory computer readable storage medium of claim 21, wherein the lens position control signal is configured for initiating a contrast autofocus operation or a laser autofocus operation in the case where the confidence level is set to the predetermined value.

23. The non-transitory computer readable storage medium of claim 21, wherein the code for determining whether the set of image data contains data representing at least one diagonal edge includes:
code for determining a ratio of a first focus score of the image data in a first direction to a second focus score of the image data in a second direction orthogonal to the first direction; and
code for determining whether the ratio is greater than a predetermined threshold value.
